(19) United States
(12) Patent Application Publication
(10) Pub. No.: US 2005/0039032 A1
(43) Pub. Date: Feb. 17, 2005

(54) Apparatus and method for authentication of computer-readable medium

(76) Inventors: Stanley Babowicz, Phoeniz, AZ (US); John Daniel Aquilino, Phoenix, AZ (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/475,160

(22) PCT Filed: Apr. 16, 2002
(86) PCT No.: PCT/US02/11915

Related U.S. Application Data
(60) Provisional application No. 60/284,100, filed on Apr. 16, 2001.

(51) Int. Cl. H04L 9/32

(52) U.S. Cl. 713/193

(57) ABSTRACT

An apparatus and method for authentication of a computer-readable medium (120) provides advantages of automating the authentication process, and further provides redundancy in processes that may be used by a customer for authentication. It enables downloading of files and/or licenses from a central server (104), and the local use of an authentication program running on the client (102), who reduces communications and processing demands on the server (104). Further advantages include the flexibility to customize the authentication approach by varying the local criteria checked during authentication. Accordingly, downloading and further copying and distribution of software or content is effectively controlled, making piracy and other unauthorized copying more difficult.

### BACKGROUND OF THE INVENTION

1. Field of the Invention

The present invention relates in general to authentication in computer systems, and, more specifically, to authentication of a computer-readable medium containing valuable informational content.

2. Description of the Related Technology

The software and entertainment industries have a strong interest in protecting valuable business software and other types of software, such as recreational game software, and music, movie and other entertainment content from unauthorized copying and distribution. The widespread use of personal computers, Internet access, and portable devices such as MP3 players has permitted extensive unauthorized distribution of software and entertainment content. As the software and entertainment industries are increasingly using the Internet for distribution of software and content to businesses and consumers, it has become important to limit this distribution to authorized customers who have properly paid for or otherwise are entitled to receive this software and content. The providing of software updates and additional entertainment content or related services through Internet distribution, for example as may be provided under subscription-based distribution models, further increases the need to control distribution to authorized customers. Also, purchasers of software often desire to interact with other users of compatible software, for example Internet-based games software, and do so through a central server computer that enables this interaction.

Prior approaches to limiting distribution to authorized customers have included efforts to authenticate the customer prior to permitting the customer to download software and/or entertainment content. These approaches include establishing an Internet connection between a client computer and a server computer and the manual entry of authenticating data by the user. Such authenticating data may include a password provided by a software or content vendor at the time of sale or specific text that is located by the user from a manual or other paper guide provided as part of the customer's purchase. A limitation of these manual approaches is the manual effort required by the customer, which may find the locating of information in a manual or typing in of a password more time-consuming or difficult than is offered in competing products. Thus, it would be desirable to have an authentication approach that is automated and does not require manual action by the customer.

Another limitation of prior manual authentication approaches is that they are susceptible to piracy because the password or other authenticating data provided to an original customer may be copied and distributed along with pirated copies of software or entertainment content. More complicated manual approaches have required the entering of additional authenticating data by the customer that varies with time or other events associated with the customer's use of a purchased computer product or on-line service, but such approaches only increase customer effort and frustration. It would be preferable for any use of such additional authentication criteria to be automated and handled without additional customer interaction.

Yet another limitation of prior manual authentication approaches is that they do not provide a convenient alternative authentication approach if the primary authentication approach fails. The typical back-up alternative requires live communication with a vendor. It would be preferred to have an automatic authentication approach with redundancy that permits at least a semi-automatic authentication approach in case the primary approach fails.

Hence, there is a need for an authentication process for controlling distribution of software and content to customers that is automated, provides redundancy, and permits more extensive checking of multiple authentication criteria without additional manual involvement by customers.

### SUMMARY OF THE INVENTION

Accordingly, it is an object of the invention to provide an authentication process for controlling distribution of software and content to customers that is automated, provides redundancy, and permits more extensive checking of multiple authentication criteria without additional manual involvement by customers.

In order to achieve the above and other objects of the invention, a method of authenticating an article of digital media having a digital work provided thereon includes identifying criteria on the article of digital media; and comparing the criteria to corresponding criteria that is know to be present on an original master version of the digital work.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating a computer system for authentication according to the present invention;

FIG. 2 illustrates the contents of a compact disc according to the present invention;

FIG. 3 is a process flow diagram illustrating a method for authentication according to the present invention;

FIG. 4 is a process flow diagram illustrating an authentication process in the authentication method of FIG. 3;

FIG. 5 is a process flow diagram illustrating a local criteria checking process in the authentication method of FIG. 4; and

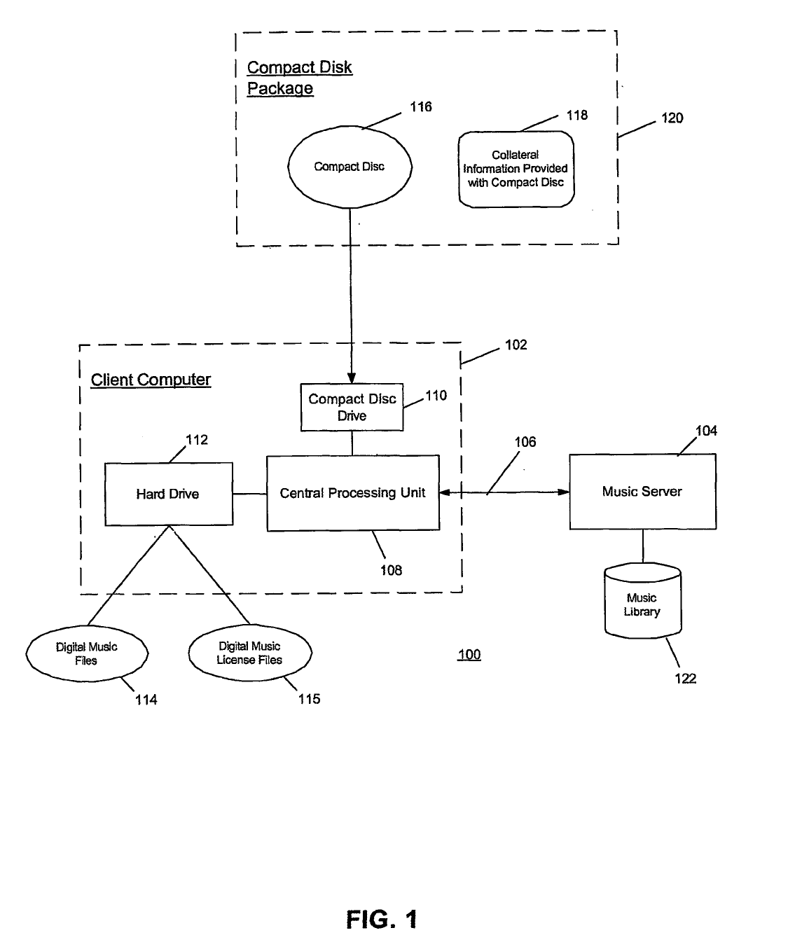

FIG is a data flow diagram illustrating data streams between the client computer and music server of FIG. 1.

### DETAILED DESCRIPTION OF THE PREFERRED EMBODIMENT(S)

Referring now to the drawings, wherein like reference numerals designate corresponding structure throughout the views, the present invention provides an apparatus and method for authenticating a computer-readable medium such as, for example, a compact disc (CD) loaded into a client computer (sometimes referred to herein as simply “client”), which is in communication with a remote server computer (sometimes referred to herein as simply “server”). In particular, according to one aspect of the present invention, the authentication is accomplished using software and data stored on the CD itself in which the software is automatically launched after insertion of the CD into a CD drive on the client and investigates one or more criteria associated with the CD and/or client as part of the authentication process. After authentication of the CD, the server authorizes downloading of digital content identical to or related to the software or content on the CD or other related new information to the client.

Although the present invention is discussed below in the non-limiting example of an audio CD, the present invention may generally be used with other types of digital storage media including, for example, CD-ROMs, CD-Rs, and DVDs. Further, the present invention is applicable in general to the protection and control of the distribution of any type of information that may be stored on a computer-readable medium such as, for example, software, data, music, and movies. Accordingly, the present invention extends to and is useful with these other media and types of information.

FIG. 1 is a block diagram illustrating a computer system 100 for authentication of a computer-readable medium, for example a compact disc 116, according to the present invention. Computer system 100 includes a client 102 and a music server 104 connected by a remote connection 106, for example a standard Internet connection. Client 102 has a central processing unit (CPU) 108, a hard drive 112 coupled to CPU 108, and a hardware unit for reading the computer-readable medium, for example compact disc drive 110. Client 102 is, for example, an Intel-based personal computer running the WINDOWS operating system from Microsoft Corporation. One skilled in the art will recognize that numerous other hardware platforms may also be used for client 102, Compact disc 116 is typically purchased by a customer in physical form in a compact disc package 120, which includes compact disc 116 and collateral information 118. Compact disc 116 is, for example, a multi-session compact disc having standard audio tracks recorded in a first session and standard digital data recorded in a second session. Compact disc 116 is read by compact disc drive 110. The audio tracks may correspond, for example, to the songs in an album produced by a music publisher. The types of digital data provided on compact disc 116 permit authentication of compact disc 116 according to the present invention as described in more detail below. The digital data recorded in the second session may additionally include protected digital copies of the music content of the first session whereby such protected content may only be accessed by the user's computer after authentication and subsequent downloading of a digital music file licenses 115 to access this digital music content. The digital file protection may be provided by any number of proprietary or commercially available Digital Rights Management apparatuses such as Microsoft's “Windows Media Rights Manager” (WMRM) or IBM's Electronic Media Management System (EMMS). According to the present invention, and if authentication of compact disc 116 has been achieved, digital music files 114 are downloaded from music server 104, or copied from the collateral information 118 stored on the second session of the compact disc 116, to client 102 and, for example, stored on hard drive 112. When content is downloaded, Server 104 selects music files 114 from a music library 122, which is a database of a large number of music files and digital music file licenses 115 corresponding to, for example, music albums for different performing artists. Music library 122 may be managed by music server 104 or by a dedicated database server (not shown) using conventional techniques. When content is alternatively copied from the collateral content 118 of the second session of the compact disc 116 the music library is pre-determined once the compact disc 116 is manufactured since the compact disc is a read-only storage medium. According to the present invention, content may be transferred to the client computer 102 hard drive 112 by being downloaded from a music server 104, copied from the collateral content 118, or through a combination of the two methods, but no data transfer may take place prior to authentication of the compact disc 116 medium which is the subject of the present invention

When compact disc 116 is inserted into drive 110, the authentication according to the present invention is executed automatically, as described in more detail below. Successful authentication of compact disc 116 enables a customer to, for example, conveniently and automatically obtain a digital version of a music album recorded on compact disc 116.

According to the present invention, music files 114 downloaded from server 104, or copied directly from the compact disc collateral information 118, typically correspond one-to-one to the content in the audio tracks of compact disc 116. Also, additional songs, for example performed by the same artist, and/or other information or content such as images and videos may be downloaded to client 102. In addition, music files 114 may be updated versions of the same songs previously recorded onto compact disc 116. Further, in other embodiments, files 114 may be software or other content files corresponding, for example, to software distributed on compact disc 116. In the case of software files, library 122 may contain regularly updated versions of the corresponding software so that the user of client 102, when in physical possession of compact disc 116, may periodically acquire updated versions of software. In yet other embodiments, other files may be stored in library 122 and/or collateral information 118 and provided to client 102 to offer related services to the purchaser of compact disc 116.

Standard audio compact disc players may be used to play the songs on compact disc 116. Also, the purchaser of compact disc package 120 may use client 102 to make copies of digital music files 114 onto compatible portable devices such as, for example, WMA and MP3 players. According to the present invention, a publisher of the informational content, for example music files, stored on compact disc 116 can better control use and distribution of the content on compact disc 116 by controlling a purchaser's ability to copy music files directly from compact disc 116 to hard drive 112. If direct copying were permitted, then a purchaser may be able to create digital copies of, for example, songs on compact disc 116 using so-called ripping software and then electronically distribute these copies without authorization to other persons. In contrast, the present invention permits more control over distribution while still providing an authorized purchaser with convenience of use of music content on multiple platforms.

One of the many available content control approaches may be used to prevent direct copying of files from compact disc 116 to hard drive 112. After authentication of compact disc 116, the purchaser is able to obtain music files 114. Copying and distribution of music files 114 after download can be controlled using a standard digital rights management approach. Thus, a purchaser is able to play compact disc 116 on standard audio players and to obtain digital files for use on the purchaser's personal computer. Authentication of compact disc 116 is now discussed in more detail below.

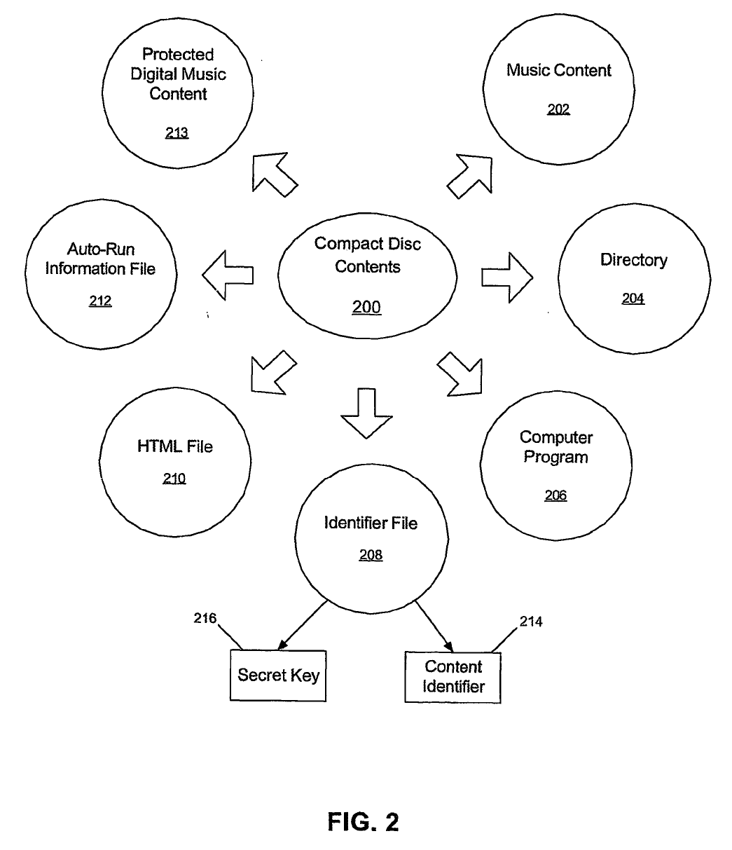

FIG. 2 illustrates the contents 200 of a computer-readable medium, for example compact disc 116, according to the present invention. As mentioned above, compact disc 116 is, for example, a multi-session disc. Music content 202 is stored in a first session and contains audio tracks corresponding, for example, to a music album and corresponding, as mentioned above, to digital music files 114. Several data files are stored in a second data session and are listed in a directory 204, which is also stored in the second session. According to the present invention, the data files include a computer program 206, an identifier file 208, an HTML file 210, an auto-run information file 212 and, optionally, protected versions of the music content 214.

Computer program 206 executes and controls the authentication method according to the present invention, as discussed in greater detail below. Computer program 206 is programmed using, for example, the C++ programming language. However, one skilled in the art will recognize in light of the following description that many other types of programming languages may be used to implement program 206. Auto-run information file 212 provides the information necessary for automatically launching computer program 206 when a user inserts compact disc 116 into drive 110. The auto-run feature is implemented using a standard approach such as, for example, available when using the WIDOWS 98 operating system from Microsoft Corporation running on an Intel-based personal computer. One skilled in the arts will recognize that similar. auto-run approaches can be implemented for other platforms such as, for example, the Apple and Sun Microsystems computer platforms.

HTML file 210 provides text and images to provide a user with information that the user may manually access in the event that computer program 206 does not automatically launch after insertion into drive 110 or remote connection 106 is not automatically established. Identifier file 208 includes a content identifier 214 and a secret key 216. Content identifier 214 is sent to music server 104 and enables server 104 to select music files 114 and/or digital music licenses 116 from music library 122 that correspond to compact disc 116. Secret key 216 is, for example, an arbitrarily selected hexadecimal string and is used as part of the authentication process as described further below.

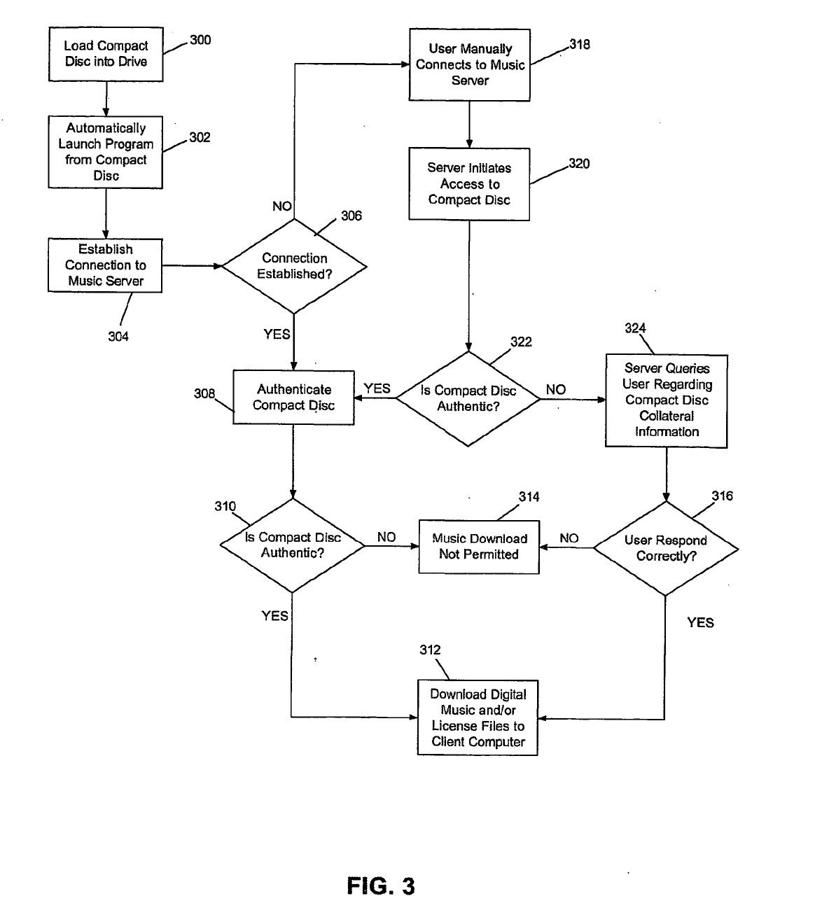

FIG. 3 is a process flow diagram illustrating a method for authentication according to the present invention. The method is generally executed under the control of computer program 206. However, some portions of the method are initiated by the user of client 102 or controlled by server 104 as described below.

In step 300, the user loads compact disc 116 into drive 110. In step 302, computer program 206 is automatically launched using the auto-run feature defined by auto-run information file 212. In step 304, program 206 attempts to establish remote connection 106. In step 306, if connection 106 is established, then authentication of compact disc 116 is attempted in step 308.

If connection 106 is not established because program 206 fails to launch, then in step 318 the user attempts to manually connect to server 104 as instructed by directions provided in collateral information 118. These directions, for example, direct the user to launch a standard browser program such as, for example, INTERNET EXPLORER from Microsoft Corporation and connect to server 104 through remote connection 106, using a URL that the user is provided in collateral information 118.

HTML file 210 contains information that the user may manually access using directory 204. This information may, for example, contain similar instructions regarding manual connection to server 104, including the appropriate URI,, as described above for collateral information 118. HTML may also contain other information of benefit to the user relating to the software or content on compact disc 116.

If program 206 is successfully launched, but remote connection 106 is not established due to a failure for some other reason, then in step 3 18 program 206 presents a pop-up informational window to the user that directs the user to manually attempt to establish remote connection 106, for example by the user's establishing a dial-up Internet connection, and to re-insert compact disc 116 into drive 110 so that program 206 once again is launched and attempts to establish a connection to server 104.

In step 320, after the user has connected to server 104, the user requests authentication of compact disc 116, and server 104 attempts to initiate authentication. In a first approach, server 104 attempts to remotely launch program 206 to perform authentication in step 308. In a second approach, server 104 downloads and executes a standard Common Object Model (COM) object, which substantially includes the same authentication functionality as program 206, to client 102 to perform authentication in step 308.

In step 322, if compact disc 116 can be accessed for authentication purposes by server 104 as described above, then the authentication process of step 308 is performed. Thus, according to the present invention, redundancy as described above is provided for the authentication method, which continues in step 308 in an automated manner.

In step 310, if authentication is successful, then in step 312 the user is permitted to download music files 114 and/or digital music file licenses 116. Server 104 downloads an HTML web page to client 102, or alternatively directs client 102 to an HTML web page already stored with compact disc collateral information 116, which is read by a standard browser component provided in program 206 and then displayed to the user. The web page presents the song tracks or other files that may be selected for download or copying to the client computer. In step 312, one or more tracks may be selected by the user and then downloaded or copied as music files 114.

In step 322, if compact disc 116 cannot be accessed, then in step 324 server 104 requests that the user review collateral information 118 for specific text content for manual entry into client 102 by the user. In step 316, server 104 compares the manually-entered text with the original text provided on collateral information 118. In an alternative approach, the user could manually obtain text from a file on compact disc 116. If the text content provided matches the original text, then in step 312 the user is permitted to obtain music files 114 as described above. If the user enters incorrect text, then in step 314 music download and/or music license download is not permitted. The manual entry of authenticating text provides additional redundancy to the foregoing authentication methods.

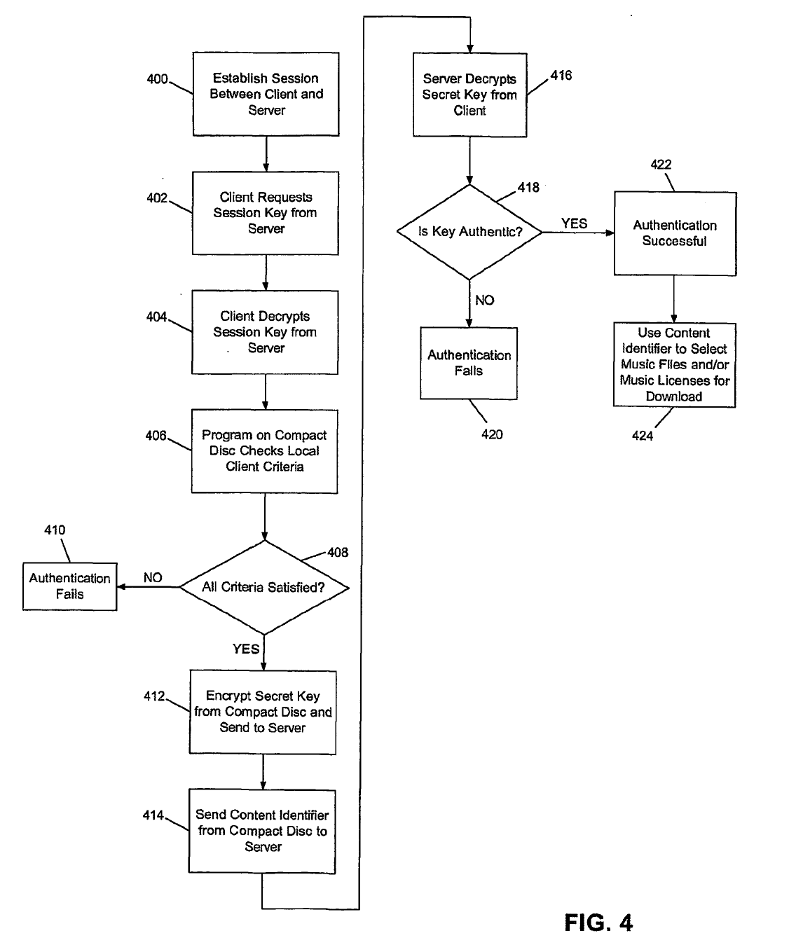

FIG. 4 is a process flow diagram illustrating the authentication process of step 308 in FIG. 3. The process of FIG. 4 is controlled by program 206. Specifically, in step 400, a secure communication session is established between client 102 and server 104 using, for example, standard encryption techniques. In step 402, client 102 requests a session key from server 104. In step 404, the session key is decrypted by client 102 and used by client 102 for identifying the session in further communications with server 104.

In step 406, program 206 checks several local criteria associated with client 102 and/or compact disc 116, as described further below. In step 408, if any one or more of the local criteria are not successfully satisfied, then in step 410 authentication fails. However, if all criteria are satisfied, then in step 412 secret key 216 is encrypted and sent to server 104. In step 414, content identifier 214 is encrypted and sent to server 104. It should be noted that, in general, all communications between client 102 and server 104, including the downloading of music files 114, are encrypted for increased security.

In step 416, server 104 decrypts secret key 216, and in step 418 checks to see if secret key 216 matches its original value as mastered onto compact disc 116. If secret key 216 matches this value, then authentication is successful in step 422, and in step 424 content identifier 214 is used to select the appropriately corresponding music files 114 for download to the user. If secret key 216 does not match, then authentication fails in step 420.

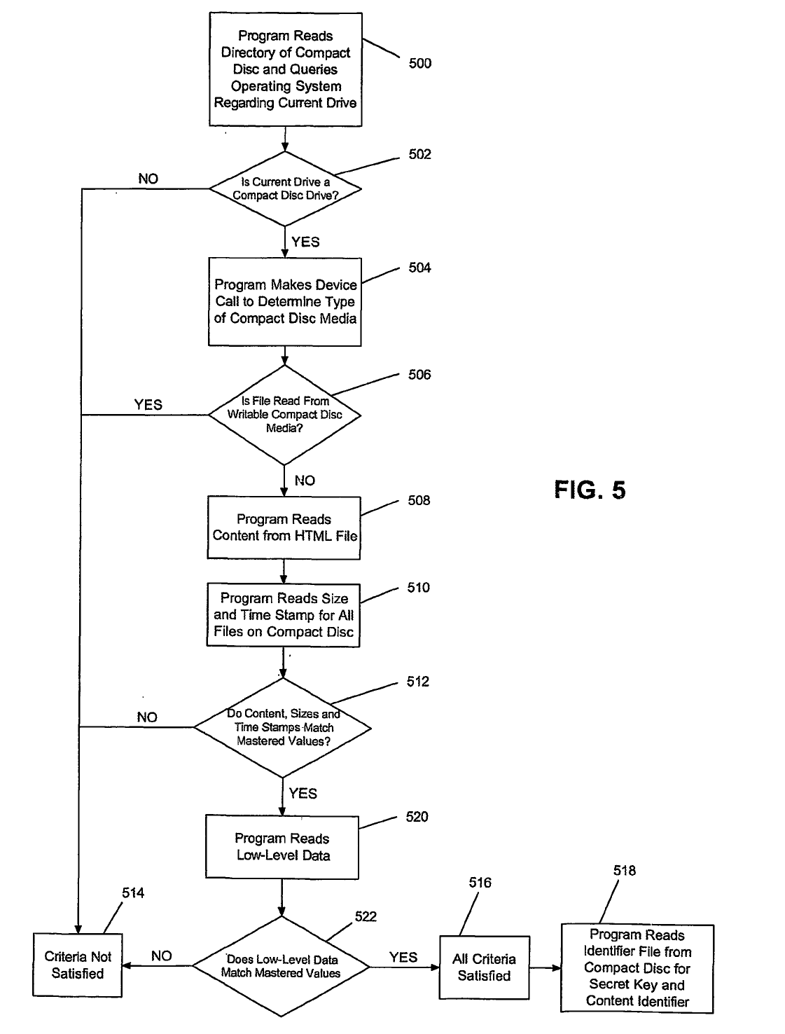

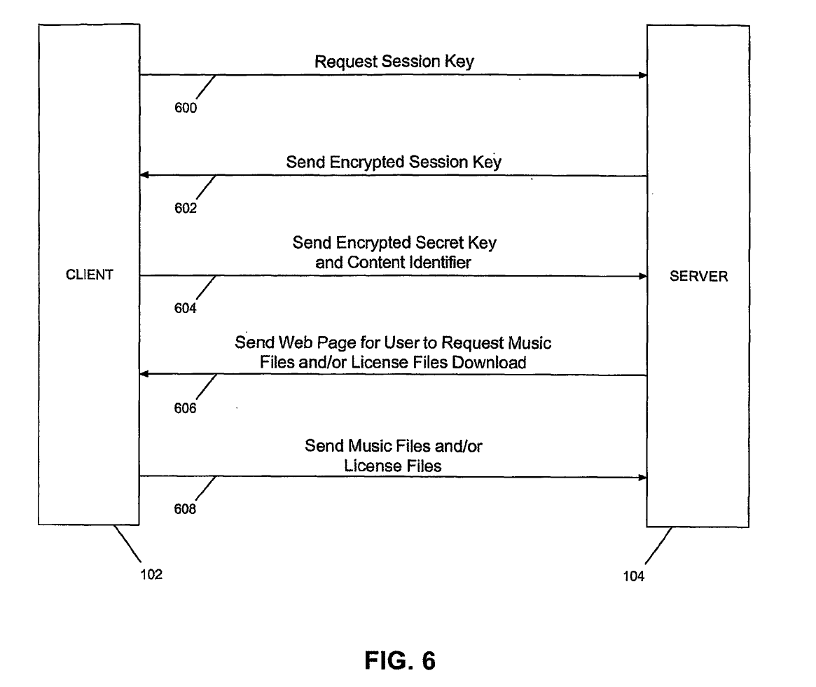

FIG. 5 is a process flow diagram illustrating the local criteria checking process of step 406 in the authentication method of FIG. 4. The local criteria are checked under the control of program 206. In step 500, program 206 reads directory 204 and makes a standard operating system call to determine if the device from which directory 204 is being read is a removable-computer-readable-medium drive such as, for example, compact disc drive 110.

In step 502, if the current drive is a removable-computer-readable-medium drive, then criteria checking continues. Otherwise, the local criteria are not satisfied in step 514. If the current drive is not a removable-computer-readable-medium drive, then it is presumed that the current drive is an unauthorized drive such as, for example, hard drive 112 onto which the user has made an unauthorized copy of compact disc 116.

In step 504, program 206 makes a standard device call, using for example a standard Small Computer Serial Interface (SCSI)/Integrated Drive Electronics (IDE) command to drive 110, to determine the type of compact disc media being read from drive 110. In one approach, compact disc contents 200 are checked for the presence of a so-called Absolute Time in Pre-Groove (ATIP) by issuing a “Read TOC/PMA/ATIP” command. An ATIP is associated with recordable compact discs (such as CD-Rs or CD-RWs) and is written onto a CD-R or CD-RW when recording content thereon.

Generally, the purchaser of compact disc package 120 is not authorized to make a copy of music content 202 to a CD-R disc. It has been found that an ATIP is generally only absent if a compact disc has been pressed from a master. Accordingly, if the contents of the ATIP are returned by this command, then it is presumed that the media is an unauthorized CD-R disc, and authentication fails. Specifically, in step 506 if an ATIP is present, then in step 514 criteria are not satisfied. If no ATIP information is returned, then this criterion is passed.

In other approaches step 504 could check other types of information from compact disc contents 200, such as information stored in the so-called lead-in or lead-out area of either an audio or data session on compact disc 116. This information may, for example, include information regarding the version of software that is distributed on compact disc 116 or that uniquely identifies the artist associated with compact disc 116.

In step 508, certain content, for example text, is read from HTML file 210 and compared to the originally mastered content. In step 510, program 206 reads the file size and time stamp for all files stored in the data session on compact disc 116. In step 512, if the content, file sizes and time stamps all match the originally mastered values, then criteria checking continues.

Otherwise, the local criteria are not satisfied in step 514.

In step 520, certain low-level content is read from compact disc 116 and inspected for known errors purposefully introduced during the mastering process. Ideally, such intentional errors should be made to sections of the compact disc 216 that can only be made dining the mastering process, that can be read by traditional compact disc readers, and that cannot be written by conventional compact disk writers (CD burners). For example, intentional errors may be introduced to the P and Q parity symbols in the EMF frame and/or to the sync bits of the P-W sub-channels in the lead-in or lead-out area of any one or multiple sessions on the compact disc 116. Optimally, such errors should be located in one of the last blocks of the lead-out area of the last session since no essential information is present in the lead-out area which will minimize any unwanted side effects of a read error.

In step 522, these intentional errors are compared to the errors in the originally mastered content and if these errors substantially match the originally mastered values, then all criteria are satisfied in step 516. Otherwise, the local criteria are not satisfied in step 514. A substantial match is all that is required for this test since compact disc degradation over time may cause certain errors to be indiscernible and so, in the current embodiment, only a simple majority (51%) of such errors must match.

Although specific local criteria have been described above, it should be appreciated that according to the present invention numerous combinations and types of other local criteria could also be checked. In step 518, program 206 reads identifier file 208 to obtain secret key 216 and content identifier 214 for sending to server 104.

FIG. 6 is a data flow diagram illustrating the primary data streams between client 102 and music server 104. In data stream 600, client 102 sends a request for a session key as described above. Then, in stream 602, server 104 sends the session key in encrypted form.

If authentication as described above is successful, then in stream 604, client 102 sends secret key 216 and content identifier 214 in an encrypted form to server 104. In stream 606, in response server 104 sends a web page that is displayed by program 206 and permits the user to customize the user's choice of music files 114 and music licenses 115 for downloading from the music server 104 and/or copying from compact disc 116. In stream 608, music files 114 and/or music licenses 115 are downloaded to client 102.

In an alternative embodiment of the present invention authentication of the compact disc 116 may be accomplished solely through the execution of computer program 206 without requiring access to the music server 104 provided the criteria checking steps taken in FIG. 5 are reduced to only those tests which may be performed with knowledge in hand prior to the mastering process. Accordingly, date and time stamp checking for all files on the compact disc 510 would have to be abandoned since program 206 would have no a priori knowledge of the date and time these files would be created since, by definition, such information may only be obtained post-mastering and computer program 206 must be created prior to mastering.

By the foregoing description, a novel apparatus and method for authentication of a computer-readable medium have been disclosed. The present invention has the advantages of automating the authentication process, providing redundancy in processes that may be used by a customer for authentication to enable downloading of files and/or licenses from a central server, and the local use of an authentication program running on the client, which reduces communications and processing demands on the server. Further advantages include the flexibility to customize the authentication approach by varying the local criteria checked during authentication. By the use of the foregoing invention, downloading and further copying and distribution of software or content is controlled and piracy and other unauthorized copying is made more difficult.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A method of authenticating an article of digital media having a digital work provided thereon, comprising steps of:
identifying criteria on the article of digital media; and
comparing the criteria to corresponding criteria that is known to be present on an original master version of the digital work.

2. A copy-protected digital storage medium, comprising:
a digital storage medium;
a digital work encoded on said digital storage medium; and
a computer program also encoded on said digital storage medium, said computer program constructed and arranged to be executable on a personal computer in order to thwart access to said digital work by said personal computer.

3. A copy-protected digital storage medium according to claim 2, wherein said digital storage medium is a compact disc.

4. A copy-protected digital storage medium according to claim 3, wherein said digital work comprises an audio work containing audio files.

5. A copy-protected digital storage medium according to claim 4, wherein said audio files are located on a first session of the compact disc.

6. A copy-protected digital storage medium according to claim 5, wherein said computer program is located on a second session of the compact disc.

7. A copy-protected digital storage medium according to claim 4, further comprising an auto-run information file on said compact disc.

8. A copy-protected digital storage medium according to claim 7, wherein said auto-run information file is configured to instruct a personal computer to execute said computer program.

9. A copy-protected digital storage medium according to claim 1, further comprising an auto-run information file on said article of digital media.

10. A copy-protected digital storage medium according to claim 9, wherein said auto-run information file is configured to instruct a personal computer to execute said computer program.

11. A copy-protected digital storage medium according to claim 1, wherein said digital storage medium comprises a standard audio compact disc that is playable by a standard audio compact disc player.

12. A copy-protected digital storage medium according to claim 11, wherein said computer program is constructed and arranged so as not to interfere with playability of said compact disc in a standard audio compact disc player.

13. A copy-protected digital storage medium according to claim 1, wherein said computer program is constructed and arranged to control a computer user's ability to digitally extract the digital work from the digital media.

14. A copy-protected digital storage medium according to claim 1, wherein said computer program is constructed and arranged to inspect low-level content from a hardware device that is provided on the personal computer for reading said digital media.

15. A method of operating a personal computer, comprising steps of:
connecting a digital storage medium bearing a digital work and a computer program to a personal computer; and
executing the computer program on the personal computer to thwart access to the digital work.

16. A method of operating a personal computer according to claim 15, wherein said digital storage medium is a compact disc.

17. A method of operating a personal computer according to claim 16, wherein said digital work comprises an audio work containing audio files.

18. A method of operating a personal computer according to claim 17, wherein said audio files are located on a first session of the compact disc.

19. A method of operating a personal computer according to claim 18, wherein said computer program is located on a second session of the compact disc.

20. A method of operating a personal computer according to claim 19, further comprising an auto-run information file on said compact disc.

21. A method of operating a personal computer according to claim 20, wherein said auto-run information file is configured to instruct a personal computer to execute said computer program.

22. A method of operating a personal computer according to claim 15, further comprising an auto-run information file on said article of digital media.

23. A method of operating a personal computer according to claim 22, wherein said step of executing the computer program comprises using said auto-run information file to instruct the personal computer to execute said computer program.

24. A method of operating a personal computer according to claim 15, wherein said digital storage medium comprises a standard audio compact disc that is playable by a standard audio compact disc player.

25. A method of operating a personal computer according to claim 24, wherein said computer program is constructed and arranged so as not to interfere with playability of said compact disc in a standard audio compact disc player.

26. A method of operating a personal computer according to claim 15, wherein said step of executing the computer program comprises controlling a computer user's ability to digitally extract the digital work from the digital media.

27. A method of operating a personal computer according to claim 15, wherein said step of executing the computer program comprises inspecting low-level content from a hardware device that is provided on the personal computer for reading said digital media.
